(19) United States
(12) Patent Application Publication
(10) Pub. No.: US 2010/0306224 A1
(43) Pub. Date: Dec. 2, 2010

(54) Online Measurement of User Satisfaction Using Long Duration Clicks

(75) Inventors: David Ciemiewicz, Mountain View, CA (US); Tapas Kanungo, San Jose, CA (US); Arun Lakshminarayanan, Sunnyvale, CA (US); Maria Stone, Pacifica, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/476,554

(22) Filed: Jun. 2, 2009

(51) Int. Cl. G06F 17/30

(52) U.S. Cl. 707/759; 707/754

(57) ABSTRACT

Determine a plurality of first dwell durations for a plurality of first web pages, each first dwell duration indicating a time period a user has spent with a first web page. Access a plurality of first quality ratings for the first web pages, each first quality rating indicating a quality of a first web page as a part of a search result generated for a first search query. Access a predefined quality rating threshold. Correlate the first dwell durations and the first quality ratings. And, determine a dwell duration threshold, such that a second user spending a second dwell duration greater than or equal to the dwell duration threshold with a second web page indicates that the second user is satisfied with the second web page identified in a second search result generated by a search engine in response to a second search query requested by the second user.

### TECHNICAL FIELD

The present disclosure generally relates to determining and improving the quality of Internet search results generated by search engines.

### BACKGROUND

The Internet provides a vast amount of information. The information is stored at many different sites, e.g., on computers, servers, in databases, etc., around the world. These different sites are communicatively linked to the Internet through various network infrastructures. Any person may access the publicly available information via a suitable network device connected to the Internet.

Due to the sheer amount of information available on the Internet, it is impractical as well as impossible for a person to manually search throughout the Internet for a specific piece of information. Instead, most people rely on different types of computer-implemented tools to help locate the desired information. One of the most commonly and widely used tools is a search engine, such as the search engine provided by Yahoo!® Inc. (http://search.yahoo.com). To search for information relating to a specific subject matter, a person typically provides a short phrase, often referred to as a “search query,” describing the subject matter to a search engine. The search engine conducts a search using the query phrase based on various search algorithms and generates a search result that includes web pages most likely to contain the desired information. The search result is then presented to the person, often in the form of a list of links, each link being associated with a different web page included in the search result. The person then is able to click on the links to view the specific web pages as he wishes.

There are continuous efforts to improve the qualities of the search results generated by the search engines. Accuracy, completeness, presentation order, and speed are but a few of the performance aspects of the search engines for improvement.

### SUMMARY

The present disclosure generally relates to determining and improving the quality of Internet search results generated by search engines.

In particular embodiments, a method, comprising: determining a plurality of first dwell durations for a plurality of first web pages, each of the first dwell durations indicating one of a plurality of first time periods one of a plurality of first users has spent with a different one of the first web pages, each of the first web pages is included in one or more of a plurality of first search results, each of the first search results is generated by a search engine in response to a different one of a plurality of first search queries; accessing a plurality of first quality ratings for the first web pages, each of the first quality ratings assigned to a different one of the first web pages by one of one or more human quality raters and indicating a quality of the first web page as a result for the first search query corresponding to the first search result that includes the first web page; accessing a quality rating threshold that is predefined; correlating the first dwell durations and the first quality ratings of the first web pages; and determining a dwell duration threshold by balancing a percentage of the first web pages having first quality ratings greater than or equal to the quality rating threshold and a percentage of the first web pages having first dwell durations greater than or equal to the dwell duration threshold, such that a second user spending a second dwell duration greater than or equal to the dwell duration threshold with a second web page indicates that the second user is satisfied with the second web page identified in a second search result generated by the search engine in response to a second search query requested by the second user.

In particular embodiments, a method comprising: accessing a dwell duration threshold, such that a first user spending a first dwell duration greater than or equal to the dwell duration threshold with a first web page indicates that the first user is satisfied with the first web page identified in a first search result generated by a search engine in response to a first search query requested by the first user, the first dwell duration indicating a first time period the first user has spent with the first web page; accessing a plurality of web sessions comprising interactions between a plurality of second users and a plurality of second web pages, each of the second web pages identified in one or more of a plurality of search results and having a different one of a plurality of second dwell durations, each of the second dwell during indicating a second time period the corresponding one of the users having spent with the corresponding one of the web pages, each of the search results generated by the search engine in response to a different one of a plurality of search queries requested by the corresponding one of the users and including one or more of the second web pages; selecting all of the web sessions during which the interactions between selected ones of the second users and selected ones of the second web pages having resulted in one or more of the second web pages having second dwell durations greater than or equal to the dwell duration threshold to obtain a first subset of the web sessions; and improving the second search result generated by the search engine in response to the second search query requested by the second user based on the first subset of the web sessions.

In particular embodiments, a method comprising: accessing a dwell duration threshold, such that a first web page having a first dwell duration greater than or equal to the dwell duration threshold indicates that a first user is satisfied with the first web page included in a first search result generated by a search engine in response to a first search query requested by the first user, the first dwell duration indicating a first time period the first user has spent with the first web page; accessing a plurality of web sessions comprising interactions between a plurality of second users and a plurality of second web pages, each of the second web pages identified in one or more of a plurality of second search results and having a different one of a plurality of second dwell durations, each of the second dwell durations indicating a second time period the corresponding one of the second users having spent with the corresponding one of the second web pages, each of the second search results generated by the search engine in response to a different one of a plurality of second search queries requested by the corresponding one of the second users and including one or more of the second web pages; selecting all of the web sessions during which the interactions between selected ones of the second users and selected ones of the second web pages have resulted in one or more of the second web pages having second dwell durations greater than or equal to the dwell duration threshold to obtain a first subset of the web sessions; and improving a third search result generated by the search engine in response to a third search query requested by a third user based on the first subset of the web sessions.

These and other features, aspects, and advantages of the disclosure are described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 illustrates an exemplary method for determining a dwell duration threshold using a set of web pages.

FIG. 2 illustrates an exemplary search result presented as a list of clickable links.

FIG. 3 illustrates an exemplary plot of dwell duration thresholds and web page percentages.

FIG. 4 illustrates an exemplary network environment suitable for implementing embodiments of the present disclosure.

FIG. 5 illustrates an exemplary computer system suitable for implementing embodiments of the present disclosure.

### DETAILED DESCRIPTION OF EXEMPLARY EMBODIMENTS

The present disclosure is now described in detail with reference to a few exemplary embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order to not unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

In particular embodiments of the present disclosure, a dwell duration threshold is determined based on a set of search queries and a set of search results. Each search result is generated by a search engine in response to a search query requested by a user and includes one or more web pages. Each web page included in a search result that has been accessed by a user has a dwell duration, which indicates a time period the user has spent with the web page. In addition, each web page included in a search result that has been accessed by a user has been rated by a human rater and received a quality rating.

From the set of web pages that have been accessed by the users and thus having dwell durations and quality ratings, determine a first percentage of the web pages having quality ratings greater than or equal to a predefined quality rating threshold and a second percentage of the web pages having dwell durations greater than or equal to the dwell duration threshold. Balance the first percentage and the second percentage to obtain a desirable value for the dwell duration threshold.

Once the dwell duration threshold has been determined, it may be used to improve subsequent search results generated by the search engine in response to subsequent search queries.

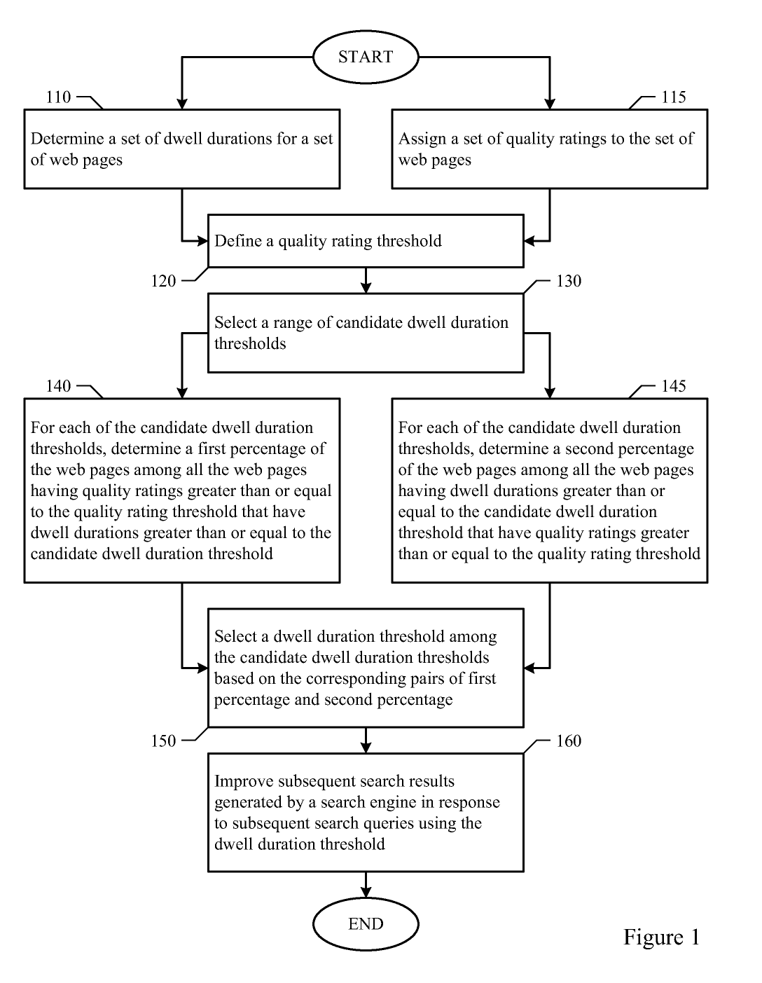

FIG. 1 illustrates an exemplary method for determining a dwell duration threshold using a set of web pages. In a typical scenario, when a person wishes to locate information with respect to a specific subject matter or a specific topic on the Internet, the person may search for the information using an Internet search engine, such as Yahoo!® Search., Google™, Live Search, etc. Such a person is often referred to as a user. The user may provide a search query that includes one or more keywords describing the subject matter. The search engine then conducts a search throughout the Internet for web pages that are most likely to contain information relating to the search query using one or more search algorithms. The web pages found by the search engine may be collectively referred to as a search result generated by the search engine in response to the search query. Often, the web pages found are presented to the user requesting the search as a list of clickable links, each link being associated with a different web page. The user may then click on the specific links to view the corresponding web pages.

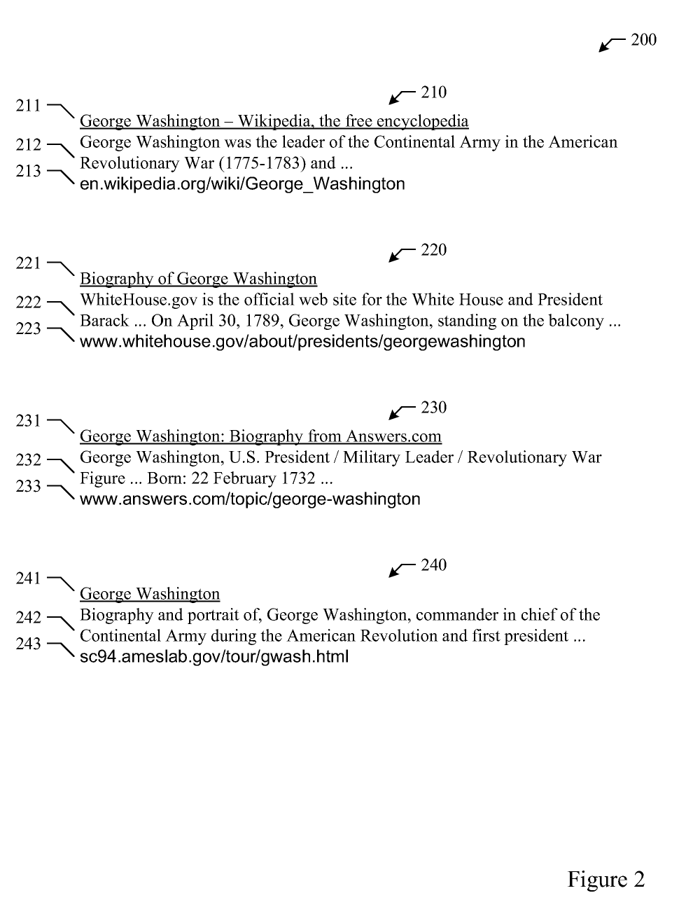

Consider a specific example. Suppose a user is looking for information on the first president of the United States. The user may provide the keywords “George Washington” as a search query to a search engine. The search engine, after conducting a search for search query “George Washington,” may present the user with a list of clickable links, each link corresponding to a web page that is most likely to contain information on President George Washington. FIG. 2 illustrates an exemplary search result 200 that includes four web pages 210, 220, 230, and 240 found for search query “George Washington.” The web pages included in FIG. 2 are for illustrative purposes only. In practice, a search result often includes many, e.g., hundreds of, web pages. Web pages 210-240 may be presented in the order of relevance, with the more relevant web pages being presented before the less relevant web pages.

In particular embodiments, each of web pages 210-240 is presented with a set of helpful information, including, for example, the title of the web page, e.g. titles 211, 221, 231, and 241, a brief summary for the web page, e.g., summaries 212, 222, 232, and 242, and the Uniform Resource Locator (URL) that identifies the web page, e.g., URLs 213, 223, 233, and 243. The user may then view the detailed contents of the individual web pages by clicking on the titles or the URLs of the web pages, which are in fact clickable links. For example, in FIG. 2, to view web page 220, the user may click on either title 221 or URL 223.

Once the user has clicked on the link corresponding to a particular web page included in the search result, the user is presented with that web page. The user may then view the detailed content contained in the web page. The user may spend different lengths of time viewing each of the web pages he has clicked on, depending on, for example, whether the user is interested in the information contained in the web pages. The time period a user spends with a web page may be referred to as the “dwell duration” the web page receives from the user.

In particular embodiments, empirical data suggest that the longer time period a user spends with a web page, i.e., the longer dwell duration a web page receives from the user, the more interested the user is in the information contained in the web page, which in turn suggest that the information contained in the web page is more closely related to the subject matter described by the search query requested by the user. Consequently, in particular embodiments, the longer dwell duration a web page receives from a user, the more accurate the web page is as a resulting web page for the search query requested by the user. Thus, a web page's dwell duration may be considered as a factor that indicates how accurate the web page is as a resulting web page to be included in the search query generated for a particular search query.

Most of the web servers that provide search engine functionalities monitor web sessions conducted via the web servers and collect web session data that describe actions and events the users perform with the search engines. The web session data often include information such as the search queries requested by the users, the search results generated by a search engine in response to the search queries, the web page links in each of the search results clicked by the users, the time each of the events or actions occurs, etc.

In particular embodiments, the web session data collected by a web server providing a search engine may be processed to determine dwell duration for each of the web pages included in the search results generated by the search engine that has been clicked by one of the users. Specifically, in particular embodiments, a dwell duration for a particular web page is measured as the period between the time a user clicking on the link corresponding to the web page and the subsequent time the same user returning to the search engine to perform another action with the search engine. The subsequent action that the user performs after returning to the search engine may be any type of action, such as, for example, clicking on the link corresponding to another web page, conducting a new search, etc.

It is possible that in some individual cases, a user may not spend the entire time period between the time he clicks on the link corresponding to a web page and the subsequent time he returns to the search engine only with the web page. For example, during the time period in question, the user may view other web pages, perform other types of online actions, such as viewing and answering his emails, or exit the Internet completely. Ideally, the dwell duration determined for a web page reflects as closely as possible the actual time the user spends with the web page. Thus, in particular embodiments, if information in addition to the web session data is available, the additional information may be used to further refine the dwell durations for the web pages.

In particular embodiments, information in addition to the dwell duration may be determined for each web page whose corresponding link has been clicked by a user from the web session data. As illustrated in FIG. 2, the web pages included in a search result are often presented to the user requesting the search as a list of clickable links corresponding to the web pages so that the user may click on the individual links to view the corresponding web pages. The list of clickable links may be organized and presented to the user using another web page, e.g., a search result web page. In particular embodiments, for each of the clickable links included in a search result that has been clicked by the user, information indicating whether the link is the last link in the search result that has been clicked by the user, whether the link is the last link within a web session that has been clicked by the user, whether the link is the last link within a web domain that has been clicked by the user, whether the web page corresponding to the link has the longest dwell duration among the web pages included in the search result may be determined.

In particular embodiments, web session data collected over some period of time may yield information on dwell durations for multiple web pages, each of the web pages having been included in one or more of the search results generated by the search engine and the link corresponding to each of the web pages having been clicked by one or more users during the period of time over which the web session data have been collected. In particular embodiments, a set of dwell durations is determined for a set of web pages (step 110). Each of the web pages is included in at least one of the search results, and the link corresponding to each of the web pages has been clicked at least once by at least one user.

Sometimes, a web page may be included in multiple search results generated in response to multiple, different search queries. For example, web page 230 illustrated in FIG. 2 may be included in a first search result generated for search query “George Washington,” a second search result generated for search query “American Presidents,” and a third search result generated for search query “American Revolutionary War.” Thus, it is possible that web page 230 may receive three different dwell durations, one corresponding to each different search query. In particular embodiments, a dwell duration is determined for a web page with respect to a particular search query, where the web page is included in a search result generated in response to the search query. Thus, a web page may have multiple dwell durations, one with respect to a different search query.

Sometimes, multiple users may conduct searches using the same search query. For example, multiple users may request information on President George Washington and conduct searches using search query “George Washington.” In this case, search result 200 is presented to each of the users searching for the information. Suppose multiple users have clicked on the link corresponding to web page 210, and yet, different users may spend different periods of time with web page 210. Thus, it is possible that web page 210 may receive multiple, different dwell durations from multiple, different users with respect to the same search query “George Washington.” In particular embodiments, a dwell duration is determined for a web page with respect to a search query as well as a user. In this case, a web page may have multiple dwell durations, one with respect to a different pair of search query and user. In particular embodiments, with respect to a particular search query, the multiple dwell durations a web page receives from the multiple users may be aggregated, e.g., averaged or summed, into a single dwell duration. The aggregated dwell duration is then considered as the dwell duration for the web page. In this case, with respect to a search query, a web page has a single dwell duration, and the dwell duration may be aggregated from the multiple dwell durations the web page receives from the multiple users all requesting the same search query.

In particular embodiments, a set of quality ratings is assigned to the set of web pages by one or more human raters (step 115). In particular embodiments, a human rater assigns a quality rating to a web page with respect to a particular search query, and the quality rating indicates how accurate the web page is as one of the web pages included in the search result generated in response to the search query.

As explained above, a web page may be included in multiple, different search results generated in response to multiple, different search queries. The web page may receive one quality rating with respect to one search query and another quality rating with respect to another search query, depending on the level of accuracy the web page is in response to the particular search query under consideration. For example, web page 230 may be included in three separate search results generated in response to three different search queries, “George Washington,” “American Presidents,” and “American Revolutionary War.” With respect to search query “George Washington,” web page 230 may be considered very accurate. With respect to search query “American Presidents,” web page 230 may still be considered fairly accurate. With respect to search query “American Revolutionary War,” web page 230 may be considered somewhat less accurate although it still relates to the subject matter of the search query. The human rater may give three different quality ratings to web page 230, one with respect to each of the search queries. The quality rating with respect to search query “George Washington” may be higher than the quality rating with respect to search query “American Presidents,” which may be higher than the quality rating with respect to search query “American Revolutionary War.”

In particular embodiments, the quality ratings are based on a scale system. More specifically, in particular embodiments, the quality ratings may be based on a numerical scale system, e.g., between numbers 1 to 5, with higher numbers representing better qualities. For example, a rating of 5 may represent “perfect” quality; a rating of 4 may represent “excellent” quality; a rating of 3 may represent “good” quality; a rating of 2 may represent “fair” quality; and a rating of 1 may represent “bad” quality.

In particular embodiments, the quality ratings assigned to the web pages may be stored in a database so that the rating information may be accessed and used when appropriate.

In particular embodiments, a quality rating threshold is defined (step 120). Depending on the specific embodiments, the quality rating threshold may be selected at any quality rating level, such as, for example, the medium quality rating level. In the above example of the numerical rating system having quality ratings between numbers 1 to 5, quality rating 3, which corresponds to “good” quality, may be selected as the quality rating threshold. Consequently, the set of web pages may be divided into two subsets, one subset including all web pages having quality ratings greater than or equal to the quality rating threshold, and the other subset including all web pages having quality ratings less than the quality rating threshold.

In particular embodiments, a dwell duration threshold is determined based on the set of dwell durations and the set of quality ratings obtained for the set of web pages in steps 110 and 115 respectively and the quality rating threshold defined in step 120. In particular embodiments, the dwell duration threshold is determined as the following.

A range of candidate dwell duration thresholds is selected (step 130). The range of candidate dwell duration thresholds includes multiple candidate dwell duration thresholds, each representing a different length of time. For each of the candidate dwell duration thresholds, two pieces of data are determined.

First, consider all of the web pages having quality ratings greater than or equal to the quality rating threshold as a subset of the web pages. Suppose this subset of the web pages is referred to as the first subset. Determine the percentage of the web pages in the first subset that have dwell durations greater than or equal to the candidate dwell duration threshold (step 140). Suppose this percentage value is referred to as the first percentage.

Second, consider all of the web pages having dwell durations greater than or equal to the candidate dwell duration threshold as another subset of the web pages. Suppose this subset of the web pages is referred to as the second subset. Determine the percentages of the web pages in the second subset that have quality ratings greater than or equal to the quality rating threshold (step 145). Suppose this percentage value is referred to as the second percentage.

Thus, each of the candidate dwell duration thresholds has a first percentage determined as described in step 140 and a second percentage determined as describe in step 145. The dwell duration threshold is selected from the candidate dwell duration thresholds by balancing each candidate dwell duration threshold's first percentage and second percentage.

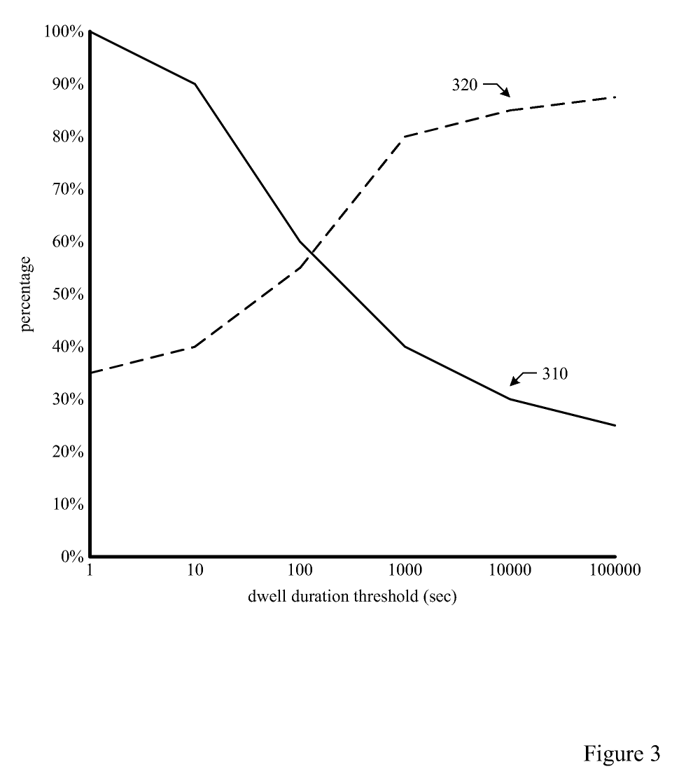

In particular embodiment, the candidate dwell duration thresholds and their first percentages may be represented as a first curve, and the candidate dwell duration thresholds and their second percentages may be represented as a second curve. FIG. 3 illustrates two exemplary curves, 310 and 320. Curves 310 and 320 are for illustrative purposes only. Curve 310 represents the first percentages plotted against the candidate dwell duration thresholds, and curve 320 represents the second percentages plotted against the candidate dwell duration thresholds. The x-axis represents the different dwell duration thresholds. The y-axis represents the different percentage levels. In particular embodiments, the dwell duration threshold is selected as the junction point of the two curves. In the example illustrated in FIG. 3, the dwell duration threshold is approximately 100 seconds.

Once the dwell duration threshold is determined, it may be used to help improve the qualities of the subsequent search results generated by a search engine in response to subsequent search queries (step 160).

In particular embodiments, web session data may be monitored and collected over a specific period of time, e.g., a day, a week, a month, etc. The collected web session data may then be processed to determine various types of information with respect to the dwell duration threshold.

For example, the web sessions occurred during the specific period of time over which the web session data are collected may be divided into categories: (1) those web sessions with no clicked web pages having dwell durations greater than or equal to the dwell duration threshold; (2) those web sessions with some clicked web pages, i.e., one or more clicked web pages, having dwell durations greater than or equal to the dwell duration threshold; and (3) those web sessions with only clicked web pages, i.e., all clicked web pages, having dwell durations greater than or equal to the dwell duration threshold. A clicked web page having a dwell duration greater than or equal to the dwell duration threshold may be referred to as a “long-click web page.”

In particular embodiments, for each category of web sessions, a probability that a user will return to the search engine to perform additional actions with the search engine, e.g., conduct more searches, is calculated. More specifically, a first probability indicating that a user will return to the search engine is calculated for the category of web sessions with no long-click web pages. A second probability indicating that a user will return to the search engine is calculated for the category of web sessions with some long-click web pages. And a third probability indicating that a user will return to the search engine is calculated for the category of web sessions with all long-click web pages. The data indicate that it is more likely that a user will not return to the search engine after a web session without any long-click web pages.

There are different ways to improve the qualities of the search results generated by a search engine in response to the search queries using the dwell duration threshold.

As illustrated in FIG. 2, each of the web pages included in a search result may be associated with a summary that briefly describes the content of the web page. The summary may help the user determine whether the particular web page contains information the user is searching for. In particular embodiments, the search engine employs a summarization algorithm to summarize the content of each of the web pages included in a search result. In particular embodiments, the dwell duration threshold may be used to improve the summarization algorithm employed by the search engine.

For example, there may be multiple candidate summarization algorithms that the search engine may employ to summarize the contents of the web pages included in the search results. A summarization algorithm may be selected from the multiple candidate summarization algorithms that results in the increase of the number of web sessions with some long-click web pages over a specific period of time. In particular embodiments, the best summarization algorithm is the one that results in the most number of web sessions with some long-click web pages over the specific period of time.

As illustrated in FIG. 2, the web pages included in a search result are presented in a particular order. Usually, the more relevant web pages are presented before the less relevant web pages. In particular embodiments, the search engine employs an order algorithm to order the web pages included in a search result. In particular embodiments, the dwell duration threshold may be used to improve the order algorithm employed by the search engine.

For example, there may be multiple candidate order algorithms that the search engine may employ to order the web pages included in the search results. An order algorithm may be selected from the multiple candidate order algorithms that results in the increase of the number of web sessions with some long-click web pages over a specific period of time. In particular embodiments, the best order algorithm is the one that results in the most number of web sessions with some long-click web pages over the specific period of time.

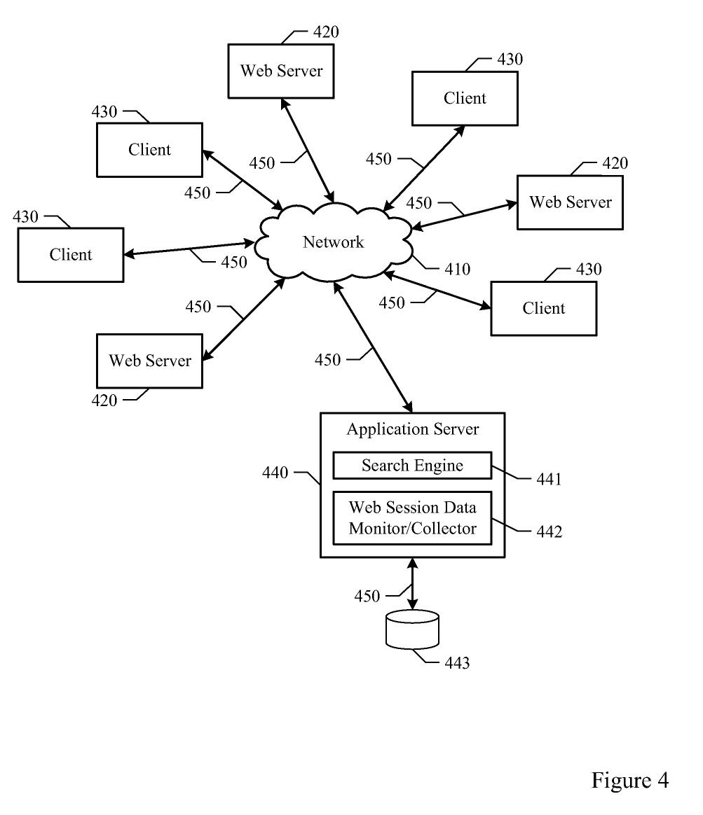

Embodiments of the present disclosure may be implemented in a network environment. FIG. 4 illustrates an exemplary network environment suitable for implementing embodiments of the present disclosure.

A network 410 couples one or more clients 430, one or more web servers 420, and an application server 440 to each other. In particular embodiments, network 410 is an Intranet, an extranet, a virtual private network (VPN), a local area network (LAN), a wireless LAN (WLAN), a wide area network (WAN), a metropolitan area network (MAN), a portion of the Internet, or another network 410 or a combination of two or more such networks 410. The present disclosure contemplates any suitable network 410. One or more links 450 couple each client 430, each web server 420, or application server 440 to network 410. In particular embodiments, one or more links 450 each includes one or more wireline, wireless, or optical links 450. In particular embodiments, one or more links 450 each includes an intranet, an extranet, a virtual private network (VPN), a LAN, a WLAN, a WAN, a MAN, a portion of the Internet, or another link 450 or a combination of two or more such links 450. The present disclosure contemplates any suitable links 450 coupling clients 430, web servers 420, and application server 440 to network 410.

In particular embodiments, a client 430 enables a user at client 430 to access web pages residing at web servers 420. As an example and not by way of limitation, a client 430 may be a computer system, such as a suitable desktop computer system, notebook computer system, or mobile telephone, having a web browser. A user at client 430 may enter a Uniform Resource Locator (URL) or other address directing the web browser to a web server 420, and the web browser may generate a Hyper Text Transfer Protocol (HTTP) request and communicate the HTTP request to web server 420. Web server 420 may accept the HTTP request and generate and communicate to client 430 a Hyper Text Markup Language (HTML) document responsive to the HTTP request.

The HTML document from web server 420 may be a web page the web browser at client 430 may present to the user. The present disclosure contemplates any suitable web pages. As an example and not by way of limitation, a web page may be an Extensible Markup Language (XML) document or an Extensible HyperText Markup Language (XHTML) document. Moreover, the present disclosure contemplates any suitable objects and is not limited to web pages residing at web servers 420. As an example and not by way of limitation, where appropriate, the present disclosure contemplates executables, files, such as, for example, MICROSOFT WORD documents and Portable Document Format (PDF) documents, or other objects residing at database servers, file servers, peer-to-peer networks, or elsewhere.

In particular embodiments, a web server 420 includes one or more servers. The present disclosure contemplates any suitable web servers 420. Moreover, the present disclosure contemplates any suitable clients 430. As an example and not by way of limitation, in addition or as an alternative to having a web browser for accessing web pages residing at web servers 420, a client 430 may have one or more applications for accessing objects residing at one or more database servers, file servers, peer-to-peer networks, or elsewhere.

In response to input of a search query from a user at a client 430, client 430 may forward the search query to application server 440. The search query may include one or more words describing the subject matter or topic of the information to be searched for.

In particular embodiments, application server 440 includes hardware, software, or embedded logic component or a combination of two or more such components for receiving and responding to search queries from clients 430. As an example and not by way of limitation, application server 440 may receive from a client 430 a search query for web pages containing one or more particular key words, accept the search query, and access a web search engine 441 to run the search query and generate a search result responsive to the search query. The search result may include one or more appropriate web pages. Application server 440 may communicate the search result to client 430 for presentation to the user. In particular embodiments, application server 440 includes one or more servers. The present disclosure contemplates any suitable application server 440. As an example and not by way of limitation, application server 440 may include a catalog server providing a point of access enabling users at clients 430 to centrally search for objects across a distributed network, such as an intranet or an extranet.

In particular embodiments, search engine 441 includes hardware, software, or embedded logic component or a combination of two or more such components for generating and returning search results identifying web pages responsive to search queries from clients 430. The present disclosure contemplates any suitable web search engine 441. As an example and not by way of limitation, web search engine 441 may be Baidu, Google, live Search, or Yahoo!® Search.

In particular embodiments, application server 440 includes a web session data monitor/collector 442. Web session data monitor/collector 442 includes hardware, software, or embedded logic component or a combination of two or more such components monitoring web sessions conducted at application server 440 and collecting web session data. The collected web session data may be stored in a database 443 accessible by application server 440 for further processing and analysis.

The method described above may be implemented as computer software using computer-readable instructions and physically stored in computer-readable medium. A “computer-readable medium” as used herein may be any medium that can contain, store, communicate, propagate, or transport the program for use by or in connection with the instruction execution system, apparatus, system or device. The computer readable medium may be, by way of example only but not by limitation, an electronic, magnetic, optical, electromagnetic, infrared, or semiconductor system, apparatus, system, device, propagation medium, or computer memory.

The computer software may be encoded using any suitable computer languages, including future programming languages. Different programming techniques can be employed, such as, for example, procedural or object oriented. The software instructions may be executed on various types of computers, including single or multiple processor devices.

Embodiments of the present disclosure may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of the present disclosure can be achieved by any means as is known in the art. Distributed, or networked systems, components and circuits can be used. Communication, or transfer, of data may be wired, wireless, or by any other means.

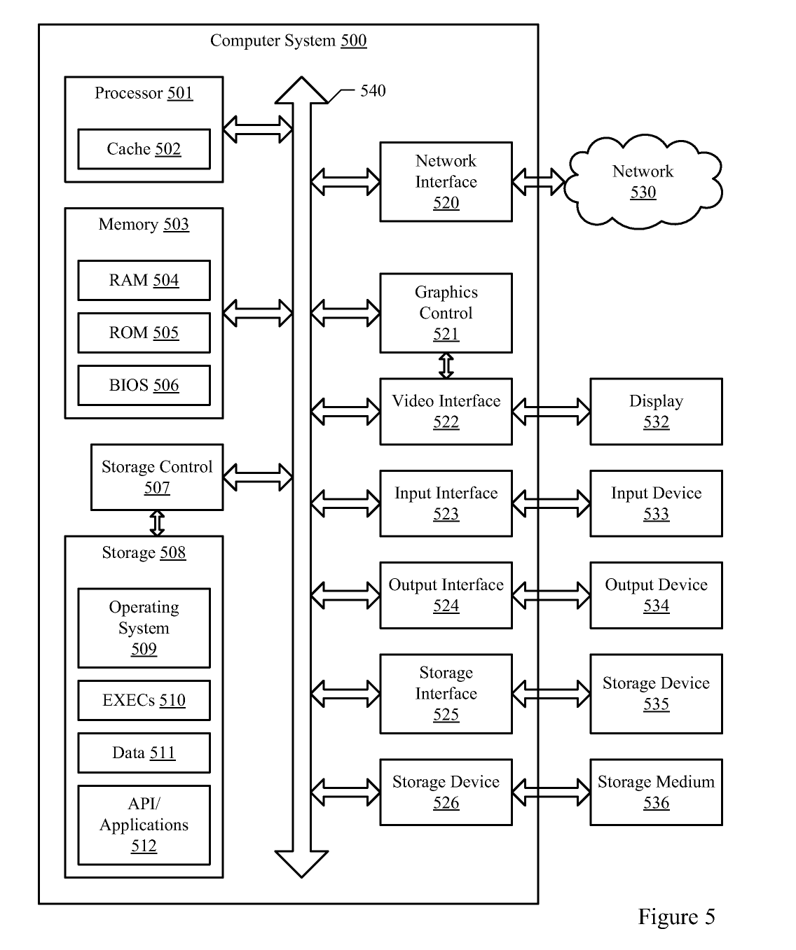

For example, FIG. 5 illustrates a computer system 500 suitable for implementing embodiments of the present disclosure. The components shown in FIG. 5 for computer system 500 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 500 may have many physical forms including an integrated circuit, a printed circuit board, a small handheld device (such as a mobile telephone or PDA), a personal computer or a super computer.

Computer system 500 includes a display 532, one or more input devices 533 (e.g., keypad, keyboard, mouse, stylus, etc.), one or more output devices 534 (e.g., speaker), one or more storage devices 535, various types of storage medium 536.

The system bus 540 link a wide variety of subsystems. As understood by those skilled in the art, a “bus” refers to a plurality of digital signal lines serving a common function. The system bus 540 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 501 (also referred to as central processing units, or CPUs) optionally contain a cache memory unit 502 for temporary local storage of instructions, data, or computer addresses. Processor(s) 501 are coupled to storage devices including memory 503. Memory 503 includes random access memory (RAM) 504 and read-only memory (ROM) 505. As is well known in the art, ROM 505 acts to transfer data and instructions uni-directionally to the processor(s) 501, and RAM 504 is used typically to transfer data and instructions in a bi-directional manner. Both of these types of memories may include any suitable of the computer-readable media described below.

A fixed storage 508 is also coupled bi-directionally to the processor(s) 501, optionally via a storage control unit 507. It provides additional data storage capacity and may also include any of the computer-readable media described below. Storage 508 may be used to store operating system 509, EXECs 510, application programs 512, data 511 and the like and is typically a secondary storage medium (such as a hard disk) that is slower than primary storage. It should be appreciated that the information retained within storage 508, may, in appropriate cases, be incorporated in standard fashion as virtual memory in memory 503.

Processor(s) 501 is also coupled to a variety of interfaces such as graphics control 521, video interface 522, input interface 523, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 501 may be coupled to another computer or telecommunications network 530 using network interface 520. With such a network interface 520, it is contemplated that the CPU 501 might receive information from the network 530, or might output information to the network in the course of performing the above-described method steps. Furthermore, method embodiments of the present disclosure may execute solely upon CPU 501 or may execute over a network 530 such as the Internet in conjunction with a remote CPU 501 that shares a portion of the processing.

According to various embodiments, when in a network environment, i.e., when computer system 500 is connected to network 530, computer system 500 may communicate with other devices that are also connected to network 530. Communications may be sent to and from computer system 500 via network interface 520. For example, incoming communications, such as a request or a response from another device, in the form of one or more packets, may be received from network 530 at network interface 520 and stored in selected sections in memory 503 for processing. Outgoing communications, such as a request or a response to another device, again in the form of one or more packets, may also be stored in selected sections in memory 503 and sent out to network 530 at network interface 520. Processor(s) 501 may access these communication packets stored in memory 503 for processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 500 may provide functionality as a result of processor(s) 501 executing software embodied in one or more tangible, computer-readable media, such as memory 503. The software implementing various embodiments of the present disclosure may be stored in memory 503 and executed by processor(s) 501. A computer-readable medium may include one or more memory devices, according to particular needs. Memory 503 may read the software from one or more other computer-readable media, such as mass storage device(s) 535 or from one or more other sources via communication interface. The software may cause processor(s) 501 to execute particular processes or particular steps of particular processes described herein, including defining data structures stored in memory 503 and modifying such data structures according to the processes defined by the software. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

A “processor,” “process,” or “act” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Although the acts, operations or computations disclosed herein may be presented in a specific order, this order may be changed in different embodiments. In addition, the various acts disclosed herein may be repeated one or more times using any suitable order. In some embodiments, multiple acts described as sequential in this disclosure can be performed at the same time. The sequence of operations described herein can be interrupted, suspended, or otherwise controlled by another process, such as an operating system, kernel, etc. The acts can operate in an operating system environment or as stand-alone routines occupying all, or a substantial part, of the system processing.

Reference throughout the present disclosure to “particular embodiment,” “example embodiment,” “illustrated embodiment,” “some embodiments,” “various embodiments,” “one embodiment,” or “an embodiment” means that a particular feature, structure, or characteristic described in connection with the embodiment is included in at least one embodiment of the present disclosure and not necessarily in all embodiments. Thus, respective appearances of the phrases “in a particular embodiment,” “in one embodiment,” “in some embodiments,” or “in various embodiments” in various places throughout this specification are not necessarily referring to the same embodiment. Furthermore, the particular features, structures, or characteristics of any specific embodiment of the present disclosure may be combined in any suitable manner with one or more other embodiments. It is to be understood that other variations and modifications of the embodiments of the present disclosure described and illustrated herein are possible in light of the teachings herein and are to be considered as part of the spirit and scope of the present disclosure.

It will also be appreciated that one or more of the elements depicted in FIGS. 1 through 5 can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Additionally, the term “or” as used herein is generally intended to mean “and/or” unless otherwise indicated. Combinations of components or steps will also be considered as being noted, where terminology is foreseen as rendering the ability to separate or combine is unclear.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
determining by one or more computer systems a plurality of first dwell durations for a plurality of first web pages, each of the first dwell durations indicating one of a plurality of first time periods one of a plurality of first users has spent with a different one of the first web pages, each of the first web pages identified in one or more of a plurality of first search results, each of the first search results generated by a search engine in response to a different one of a plurality of first search queries;
accessing a plurality of first quality ratings for the first web pages, each of the first quality ratings assigned to a different one of the first web pages by one of one or more human quality raters and indicating a quality of the first web page as a result for the first search query corresponding to the first search result that includes the first web page;
accessing a quality rating threshold that is predefined;
correlating the first dwell durations and the first quality ratings of the first web pages; and
determining a dwell duration threshold by balancing a percentage of the first web pages having first quality ratings greater than or equal to the quality rating threshold and a percentage of the first web pages having first dwell durations greater than or equal to the dwell duration threshold, such that a second user spending a second dwell duration greater than or equal to the dwell duration threshold with a second web page indicates that the second user is satisfied with the second web page being included in a second search result generated by the search engine in response to a second search query requested by the second user.

2. The method recited in claim 1, wherein each of the dwell durations for the corresponding one of the web pages is measured from a first time that the corresponding one of the users clicks on a link to the web page to a second time that the corresponding user performs a subsequent action with the search engine.

3. The method recited in claim 1, wherein:
the quality ratings are based on a numerical rating system with a relatively higher number indicating a relatively higher quality and a relatively lower number indicating a relatively lower quality, and
the quality rating threshold is a medium number within the numerical rating system.

4. The method recited in claim 1, wherein determining the dwell duration threshold comprises:
selecting all of the first web pages having first quality ratings greater than or equal to the quality rating threshold to obtain a first subset of the first web pages;
determining a first percentage of the first web pages from the first subset of the first web pages having first dwell durations greater than or equal to the dwell duration threshold;
selecting all of the first web pages having first dwell durations greater than or equal to the dwell duration threshold to obtain a second subset of the first web pages;
determining a second percentage of the first web pages from the second subset of the first web pages having first quality ratings greater than or equal to the quality rating threshold; and
adjusting the dwell duration threshold to maximize a combination of the first percentage and the second percentage.

5. The method recited in claim 1, further comprising:
improving the second search result generated by the search engine in response to the second search query using the dwell duration threshold.

6. The method recited in claim 5, further comprising:
improving a summarization algorithm employed by the search engine to summarize each of a plurality of second web pages included in the second search result using the dwell duration threshold.

7. The method recited in claim 5, further comprising:
improving an order algorithm employed by the search engine to present a plurality of second web pages included in the second search result using the dwell duration threshold.

8. A method, comprising:
accessing by one or more computer systems a dwell duration threshold, such that a first web page having a first dwell duration greater than or equal to the dwell duration threshold indicates that a first user is satisfied with the first web page identified in a first search result generated by a search engine in response to a first search query requested by the first user, the first dwell duration indicating a first time period the first user has spent with the first web page;
accessing a plurality of web sessions comprising interactions between a plurality of second users and a plurality of second web pages, each of the second web pages identified in one or more of a plurality of second search results and having a different one of a plurality of second dwell durations, each of the second dwell durations indicating a second time period the corresponding one of the second users having spent with the corresponding one of the second web pages, each of the second search results generated by the search engine in response to a different one of a plurality of second search queries requested by the corresponding one of the second users and including one or more of the second web pages;
selecting all of the web sessions during which one or more of the second web pages having second dwell durations greater than or equal to the dwell duration threshold to obtain a first subset of the web sessions; and
improving a third search result generated by the search engine in response to a third search query requested by a third user based on the first subset of the web sessions.

9. The method recited in claim 8, further comprising:
selecting all of the web sessions during which no second web page having second dwell duration greater than or equal to the dwell duration threshold to obtain a second subset of the web sessions; and
improving the third search result generated by the search engine in response to the third search query further based on the second subset of the web sessions.

10. The method recited in claim 9, further comprising:
selecting all of the web sessions during which all web second pages having second dwell durations greater than or equal to the dwell duration threshold to obtain a third subset of the web sessions; and
improving the third search result generated by the search engine in response to the third search query further based on the second subset of the web sessions.

11. The method recited in claim 8, further comprising:
adjusting a summarization algorithm employed by the search engine to increase a number of the web sessions included in the first subset of the web sessions; and
summarizing each of a plurality of third web pages included in the third search result using the adjusted summarization algorithm.

12. The method recited in claim 8, further comprising:
adjusting an order algorithm employed by the search engine to increase a number of the web sessions included in the first subset of the web sessions; and
ordering a plurality of third web pages included in the third search result for presentation to the third user using the adjusted order algorithm.

13. A computer program product comprising a plurality of computer program instructions physically stored in a computer-readable medium, wherein the plurality of computer program instructions are operable to cause at least one computing device to:
determine a plurality of first dwell durations for a plurality of first web pages, each of the first dwell durations indicating one of a plurality of first time periods one of a plurality of first users has spent with a different one of the first web pages, each of the first web pages is included in one or more of a plurality of first search results, each of the first search results is generated by a search engine in response to a different one of a plurality of first search queries;
access a plurality of first quality ratings for the first web pages, each of the first quality ratings assigned to a different one of the first web pages by one of one or more human quality raters and indicating a quality of the first web page as a result for the first search query corresponding to the first search result that includes the first web page;
access a quality rating threshold that is predefined;
correlate the first dwell durations and the first quality ratings of the first web pages; and
determine a dwell duration threshold by balancing a percentage of the first web pages having first quality ratings greater than or equal to the quality rating threshold and a percentage of the first web pages having first dwell durations greater than or equal to the dwell duration threshold, such that a second user spending a second dwell duration greater than or equal to the dwell duration threshold with a second web page indicates that the second user is satisfied with the second web page identified in a second search result generated by the search engine in response to a second search query requested by the second user.

14. The computer program product recited in claim 13, wherein each of the dwell durations for the corresponding one of the web pages is measured from a first time that the corresponding one of the users clicks on a link to the web page to a second time that the corresponding user performs a subsequent action with the search engine.

15. The computer program product recited in claim 13, wherein:
the quality ratings are based on a numerical rating system with a relatively higher number indicating a relatively higher quality and a relatively lower number indicating a relatively lower quality, and
the quality rating threshold is a medium number within the numerical rating system.

16. The computer program product recited in claim 13, wherein to determine the dwell duration threshold comprises:
select all of the first web pages having first quality ratings greater than or equal to the quality rating threshold to obtain a first subset of the first web pages;
determine a first percentage of the first web pages from the first subset of the first web pages having first dwell durations greater than or equal to the dwell duration threshold;
select all of the first web pages having first dwell durations greater than or equal to the dwell duration threshold to obtain a second subset of the first web pages;
determine a second percentage of the first web pages from the second subset of the first web pages having first quality ratings greater than or equal to the quality rating threshold; and
adjust the dwell duration threshold to maximize a combination of the first percentage and the second percentage.

17. The computer program product recited in claim 13, wherein the plurality of computer program instructions are further operable to cause the at least one computing device to:
improve the second search result generated by the search engine in response to the second search query using the dwell duration threshold.

18. The computer program product recited in claim 17, wherein the plurality of computer program instructions are further operable to cause the at least one computing device to:
improve a summarization algorithm employed by the search engine to summarize each of the plurality of second web pages included in the second search result using the dwell duration threshold.

19. The computer program product recited in claim 17, wherein the plurality of computer program instructions are further operable to cause the at least one computing device to:
improve an order algorithm employed by the search engine to present the plurality of second web pages included in the second search result using the dwell duration threshold.
